(19) United States
(12) Patent Application Publication
(10) Pub. No.: US 2020/0042280 A1
(43) Pub. Date: Feb. 6, 2020

(54) INSTANT MESSAGING APPARATUS AND METHOD

(71) Applicants: ZHEJIANG GEELY HOLDING GROUP CO., LTD, Hangzhou (CN); ZHEJIANG GEELY AUTOMOBILE RESEARCH INSTITUTE CO., LTD, Taizhou (CN)

(72) Inventor: Shufu LI, Hangzhou (CN)

(21) Appl. No.: 16/062,755

(22) PCT Filed: Dec. 13, 2016
(86) PCT No.: PCT/CN2016/109727

§ 371 Date: Aug. 22, 2018

(30) Foreign Application Priority Data
Dec. 15, 2015 (CN) 201510940310.6

(51) Int. Cl. G06F 3/16; H04L 12/58; H04M 1/725; G06F 3/0488; G06F 3/0481

(52) U.S. Cl. CPC G06F 3/165; H04L 51/04; H04M 1/7255; H04M 2250/22; H04L 51/38; G06F 3/04883; G06F 3/0481; H04L 51/10

(57) ABSTRACT

The present invention provides an instant messaging device and method, which relates to the field of communications. The instant messaging device comprises: a touchable screen for displaying a touch action; a touch detector for detecting a touch action; an action interpreter for sending out a control instruction corresponding to the touch action in response to the touch action; and a voice recorder for starting recording in response to the instruction of voice recording, and in response to the instruction of voice sending, stopping recording and sending currently recorded voice to a receiver in the instant messaging interface. By means of the above-mentioned structure, the instant messaging device of the present invention realizes blind operation of voice communication.

### TECHNICAL FIELD

The present invention relates to the technical field of communications, especially to an instant messaging device and method.

### BACKGROUND OF THE INVENTION

With the development of mobile communication technology, an instant messaging device and method are more and more widely applied, and voice information are gradually more popular at present than text information in the past, for example, Wechat, whatsapp, etc. are widely welcomed among mobile terminal users.

Moreover, voice information is for replacing the text information function; the voice information function utilizes the conversation mode of imitating two-way radio and records voice information by pressing a key and sending the voice information by releasing the key, so that the user experiences the fun of instant communication. In this way, not only text entry from the user can be reduced, instant communication can be conveniently used when the user is under the condition of, for example, driving, improving the convenience and fastness of instant messaging, and thus improving usage experience of the user.

However, sending voice information in a current instant messaging device and method needs a virtual button being pressed at a specific position for operation, and the user can only click the correct position by watching the screen, bringing usage trouble for the user to some extent, increasing the number of times of lowering the head to operate, taking driving as an example, increasing the risk of operation during driving.

### SUMMARY OF THE INVENTION

One purpose of the present invention is to provide an instant messaging device capable of realizing blind operation of a user.

One further purpose of the present invention is to provide an instant messaging method capable of realizing blind operation of a user.

Particularly, the present invention provides an instant messaging device, comprising:

a touchable screen for displaying an instant messaging interface and capable of receiving a touch action from a user;

a touch detector for detecting the touch action of the user on the touchable screen, wherein the touch action comprises an action of voice recording and an action of voice sending;

an action interpreter for sending out a control instruction corresponding to the touch action in response to the touch action, wherein when the touch action serves as the action of voice recording, the corresponding control instruction is an instruction of voice recording, and when the touch action is the action of voice sending, the corresponding control instruction is an instruction of voice sending; and

a voice recorder for starting recording in response to the instruction of voice recording, and in response to the instruction of voice sending, stopping recording and sending the currently recorded voice to a receiver in the instant messaging interface.

Further, the action of voice recording is formed by the user continuously pressing the touchable screen at any position of the instant messaging interface for a pre-determined time period; and

the action of voice sending is formed by the user continuously pressing the touchable screen at the current position and then releasing after sending the instruction of voice recording.

Further, the action of voice recording is formed by the user continuously pressing the touchable screen at any position of the instant messaging interface for a pre-determined time period and then double clicking the touchable screen for a plurality of times, wherein the double clicks refers to continuously clicking the same position or approximately the same position more than twice;

the action of voice sending is formed by the user pressing and then releasing the touchable screen at any position of the instant messaging interface after sending out the instruction of voice recording;

optionally, the number of double clicks is within six; and

optionally, the time interval between two double clicks is 1 second, or is not greater than 1 second, preferably not greater than 0.5 second.

Further, the instant messaging device also comprises:

a prompter for sending out a prompt signal to a user in response to an instruction of recording prompt,

wherein the action interpreter is also configured to send out the instruction of recording prompt in response to the action of voice recording; and

optionally, the instruction of recording prompt and the instruction of voice recording are simultaneously sent out by the action interpreter.

Further, the prompter comprises:

a graphic prompt unit for presenting a pre-determined prompt graph in the instant messaging interface in response to the instruction of recording prompt; optionally, the prompt graph is a virtual button centred at the current position; and optionally, the virtual button is a circular virtual button, a square virtual button or a rectangular virtual button;

a vibration prompt unit for enabling the touchable screen to vibrate in response to the instruction of recording prompt; and/or

an audio prompt unit for sending out a prompt tone in response to the instruction of recording prompt.

Further, the touch action further comprises an action of cancelling voice-sending, a corresponding control instruction of which is an instruction of cancelling voice-sending,

wherein the voice recorder stops the recording and does not execute the voice-sending operation in response to the instruction of cancelling voice-sending.

Further, the action of cancelling voice-sending is a sliding operation from the current position to another position executed by the user on the touchable screen after the instruction of voice recording is sent out; and

optionally, the action of cancelling voice-sending is a sliding operation from the current position to another position along any direction.

Further, the instant messaging device also comprises:

a graphic prompt unit for presenting a virtual button centred at the current position in the instant messaging interface in response to the instruction of recording prompt;

the action of cancelling voice-sending is a sliding operation of sliding from the current position to a position other than the virtual button along any direction; and

optionally, the virtual button is a circular virtual button, a square virtual button or a rectangular virtual button.

Further, the action of voice recording is formed by the user continuously pressing the touchable screen at any position of the instant messaging interface for a pre-determined time period; and

the action of voice sending is formed by the user continuously pressing the touchable screen at the current position and then releasing after sending the instruction of voice recording; and

the action of cancelling voice-sending and the action of voice recording are actions executed continuously without releasing the touchable screen.

Further, the instant messaging device also comprises:

a voice judger for determining a signal to noise ratio of the recorded voice; and

a window generator for generating a confirmation window in the instant messaging interface in response to the action of voice sending when the signal to noise ratio is lower than a pre-set threshold, and for receiving a confirmation instruction manually input by the user indicating whether it is allowed to send out the recorded voice,

wherein the voice recorder is also configured to send the currently recorded voice to the receiver in the instant messaging interface in response to a confirmation instruction input by the user indicating that sending out is allowed when the signal to noise ratio is lower than the pre-set threshold.

Further, the instant messaging device also comprises:

a listening-state device for recording the number of times that the user listens to the received specific voice; and

a synchronizer for synchronizing the number of listening times to an instant message interface of a sender of the specific voice.

The present invention also provides an instant messaging method applied to a device with a touchable screen, wherein the touchable screen is used for displaying an instant messaging interface and is capable of receiving a touch action from a user, and the instant messaging method is carried out according to the following steps:

a step of touch detection of detecting the touch action of the user on the touchable screen, wherein the touch action comprises an action of voice recording and an action of voice sending;

a step of action interpretation of sending out a control instruction corresponding to the touch action in response to the touch action, wherein when the touch action serves as the action of voice recording, the corresponding control instruction is an instruction of voice recording, and when the touch action is the action of voice sending, the instruction of corresponding control is an instruction of voice sending; and

a step of voice recording of starting recording in response to the instruction of voice recording, and in response to the instruction of voice sending, stopping recording and sending the currently recorded voice to a receiver in the instant messaging interface.

Further, the action of voice recording is formed by the user continuously pressing the touchable screen at any position of the instant messaging interface for a pre-determined time period; and

and the action of voice sending is formed by the user continuously pressing the touchable screen at the current position and then releasing after sending the instruction of voice recording.

Further, the action of voice recording is formed by the user continuously pressing the touchable screen at any position of the instant messaging interface is for a pre-determined time period and then double clicking the touchable screen for a plurality of times, wherein the double clicks refers to continuously clicking the same position or approximately the same position more than twice;

the action of voice sending is formed by the user pressing and then releasing the touchable screen at any position of the instant messaging interface after sending out the instruction of voice recording;

optionally, the number of double clicks is within six; and

optionally, the time interval between two double clicks is 1 second, or is not greater than 1 second, preferably not greater than 0.5 second.

Further, the instant messaging method also comprises:

a step of prompting of sending out a prompt signal to a user in response to an instruction of recording prompt,

wherein the step of action interpretation is also configured to send out the instruction of recording prompt in response to the action of voice recording; and

optionally, the instruction of recording prompt and the instruction of voice recording are simultaneously sent out by the step of action interpretation.

Further, the prompting step comprises:

a step of graphic prompt of presenting a pre-determined prompt graph in the instant messaging interface in response to the instruction of recording prompt; optionally, the prompt graph is a virtual button centred at the current position; and optionally, the virtual button is a circular virtual button, a square virtual button or a rectangular virtual button;

a step of vibration prompt of enabling the touchable screen to vibrate in response to the instruction of recording prompt; and/or

a step of audio prompt of sending out a prompt tone in response to the instruction of recording prompt.

Further, the touch action further comprises an action of cancelling voice-sending, a corresponding control instruction of which is an instruction of cancelling voice-sending,

wherein the step of voice recording stops the recording and does not execute the voice sending operation in response to the instruction of cancelling voice-sending.

Further, the action of cancelling voice-sending is a sliding operation from the current position to another position executed by the user on the touchable screen after the instruction of voice recording is sent out; and

optionally, the action of cancelling voice-sending is a sliding operation from the current position to another position along any direction.

Further, the instant messaging method also comprises:

a step of graphic prompt of presenting a virtual button centred at the current position in the instant messaging interface in response to the instruction of recording prompt;

the action of cancelling voice-sending is a sliding operation of sliding from the current position to a position other than the virtual button along any direction; and

optionally, the virtual button is a circular virtual button, a square virtual button or a rectangular virtual button.

Further, the action of voice recording is formed by the user continuously pressing the touchable screen at any position of the instant messaging interface for a pre-determined time period; and

the action of voice sending is formed by the user continuously pressing the touchable screen at the current position and then releasing after sending the instruction of voice recording; and

the action of cancelling voice-sending and the action of voice recording are actions executed continuously without releasing the touchable screen.

Further, the instant messaging method also comprises:

a step of voice judgement of determining a signal to noise ratio of the recorded voice; and

a step of window generation of generating a confirmation window in the instant messaging interface in response to the action of voice sending when the signal to noise ratio is lower than a pre-set threshold, so as to receive a confirmation instruction manually input by the user indicating whether it is allowed to send out the recorded voice,

wherein the step of voice recording is also configured to send the currently recorded voice to the receiver in the instant messaging interface in response to a confirmation instruction input by the user indicating that sending out is allowed when the signal to noise ratio is lower than the pre-set threshold.

Further, the instant messaging method also comprises:

a step of listening state of recording the number of times that the user listens to the received specific voice; and

a step of synchronization of synchronizing the number of listening times to an instant message interface of a sender of the specific voice.

With regard to the instant messaging device of the present invention, by means of the touch detector, the action interpreter and the voice recorder, the user continuously presses the instant messaging interface at any position to realize voice recording, and the user keeps pressing and then releases the touchable screen at the current position to realize voice sending; blind operation of voice communication is realized, thus the number of times that a user yields his/her head to operate an instant messaging device tends to zero, improving the convenience and fastness of operation to a great extent, and, taking driving as an example, thereby effectively reducing the risk of driving.

With regard to the instant messaging method of the present invention, by means of the step of touch detection, the step of action interpretation, and the step of voice recording, the user continuously presses the instant messaging interface at any position to realize voice recording, and the user keeps pressing and then releases the touchable screen at the current position to realize voice sending; blind operation of voice communication is realized, thus the number of times that a user yields his/her head to operate an instant messaging device tends to zero, improving the convenience and fastness of operation to a great extent, and, taking driving as an example, thereby effectively reducing the risk of driving.

According to the detailed description of specific embodiments of the present invention below in conjunction with the accompanying drawings, the above and other objectives, advantages and features will become more apparent to a person skilled in the art.

### BRIEF DESCRIPTION OF THE DRAWINGS

Some specific embodiments of the present invention will be described below in detail with reference to the accompanying drawings by way of example but not by way of limitation. The same reference signs indicate the same or similar components or parts in the accompanying drawings. It is understood by a person skilled in the art that the drawings are not drawn to scale necessarily. In the accompanying drawings:

FIG. 1 is a schematic assembly drawing of an instant messaging device according to one embodiment of the present invention being mounted in a mobile phone;

FIG. 2 is logic control diagram of an instant messaging device according to one embodiment of the present invention; and

FIG. 3 is an operational flowchart of an instant messaging method according to another embodiment of the present invention.

### DETAILED DESCRIPTION OF THE INVENTION

### Embodiment 1

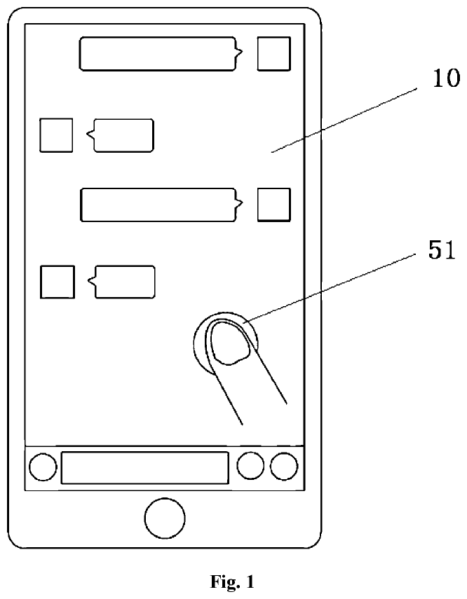

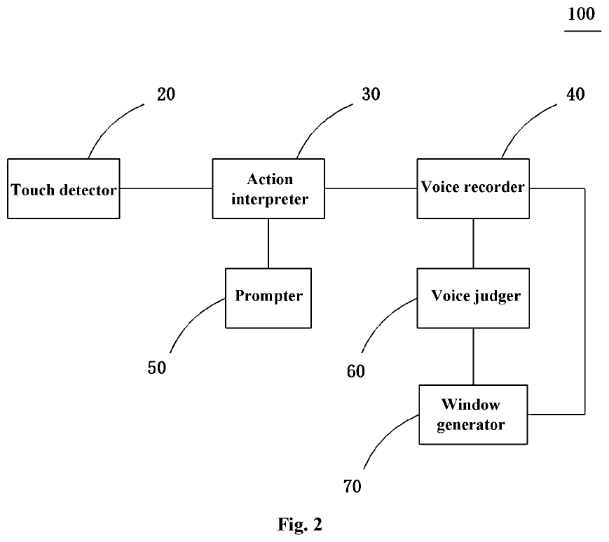

FIG. 1 is a schematic assembly drawing of an instant messaging device according to one embodiment of the present invention being mounted in a mobile phone. FIG. 2 is logic control diagram of an instant messaging device according to one embodiment of the present invention. In this embodiment, explanation is made by mainly relying on FIG. 2, and reference can also be made to FIG. 1; the instant messaging device 100 can generally comprise:

a touchable screen 10 (see FIG. 1) for displaying an instant messaging interface and capable of receiving a touch action from a user;

a touch detector 20 for detecting the touch action of the user on the touchable screen 10, the touch action comprising an action of voice recording and an action of voice sending, wherein in this embodiment

the action of voice recording is formed by the user continuously pressing the touchable screen 10 at any position of the instant messaging interface for a pre-determined time period; and

the action of voice sending is formed by the user continuously pressing the touchable screen 10 at the current position and then releasing, after the instruction of voice recording is sent out; and

an action interpreter 30 for sending out a control instruction corresponding to the touch action in response to the touch action, wherein when the touch action serves as the action of voice recording, the corresponding control instruction is an instruction of voice recording, and when the touch action is the action of voice sending, the instruction of corresponding control is an instruction of voice sending; and

a voice recorder 40 for starting recording in response to the instruction of 11) voice recording, and, in response to the instruction of voice sending, stopping recording and sending the currently recorded voice to a receiver in the instant messaging interface.

TABLE 1

| Touch action of | Instruction of | |
|---|---|---|
| touch detector | action interpreter | Mode of voice recorder |
| Action of | Instruction of | Start recording |
| voice recording | voice recording | |
| Action of | Instruction of | Stop recording and send currently |
| voice sending | voice sending | recorded voice to receiver |

Table 1 is a corresponding relationship table of the touch detector 20, the action interpreter 30 and the voice recorder 40. See FIG. 2, in this embodiment, explanation is made by taking a mobile phone among mobile terminals as an example, by way of a user's finger or using a touch tool, for example a stylus pen, to press a touchable screen 10 of the mobile phone at any position for a pre-determined time period T, for example T being greater than 1 second, the touch detector 20 detects that the touch action of the user is an action of voice recording, and the corresponding action interpreter 30 provides a corresponding instruction of voice recording, and the voice recorder 40 starts recording; the user's finger or using the touch tool, for example the stylus pen, continuously presses the touchable screen 10 of the mobile phone and then releases the touchable screen 10, the touch detector 20 detects that the touch action of the user is an action of voice sending, the corresponding action interpreter 30 provides a corresponding instruction of voice sending, and the voice recorder 40 stops recording and sending the currently recorded voice to the receiver.

With regard to the instant messaging device 100 of the present invention, by means of the touch detector 20, the action interpreter 30 and the voice recorder 40, the user continuously presses the instant messaging interface at any position to realize voice recording, and the user keeps pressing and then releases the touchable screen 10 at the current position to realize voice sending; blind operation of voice communication is realized without the need for the user to watch the screen to find the recording key, thus the number of times that a user yields his/her head to operate an instant messaging device 100 tends to zero, improving the convenience and fastness of operation to a great extent, and, taking driving as an example, thereby effectively reducing the risk of driving.

See FIG. 1, in another embodiment, the action of voice recording is formed by the user continuously pressing the touchable screen 10 at any position of the instant messaging interface for a pre-determined time period and then double clicking the touchable screen for a plurality of times. Preferably, the number of is double clicks is within six. The time interval between two double clicks is 1 second, or is not greater than 1 second, preferably not greater than 0.5 second. Of course, on other embodiments, another double click time and a corresponding time interval can also be choosing, as long as the purpose of continuously pressing can be reached. The action of voice sending is formed by the user pressing and then releasing the touchable screen 10 at any position of the instant messaging interface after sending out the instruction of voice recording.

By means of the above-mentioned operation, this embodiment not only realizes blind operation of voice communication, thus the number of times that a user yields his/her head to operate an instant messaging device 100 tends to zero, improving the convenience and fastness of operation to a great extent, and, taking driving as an example, thereby effectively reducing the risk of driving, but also realizes hands-free operation, further improving the convenience and fastness of the instant messaging device and the convenient of operation.

See FIG. 2, further, in this embodiment, the instant messaging device 100 can further comprise: a prompter 50, and the prompter 50 is used for sending a prompt signal to a user in response to an instruction of recording prompt,

wherein the action interpreter 30 is also configured to send out the instruction of recording prompt in response to the action of voice recording. Optionally, the instruction of recording prompt and the instruction of voice recording are simultaneously sent out by the action interpreter 30.

In this embodiment, by adding a prompter before recording voice, the problem that a user often speaks too early and the beginning of the voice record is not recorded due to that the user does not know when to start recording is solved, improving user experience.

See FIG. 2, further, the prompter 50 comprises a graphic prompt unit, a vibration prompt unit and/or an audio prompt unit. The prompter 50 can be a single graphic prompt unit, a vibration prompt unit or an audio prompt unit, can also be a graphic prompt unit and a vibration prompt unit, can also be a graphic prompt unit and an audio prompt unit, can also be a vibration prompt unit and an audio prompt unit, and can also be a graphic prompt unit, a vibration prompt unit and an audio prompt unit.

The graphic prompt unit is used for presenting a pre-determined prompt graph in the instant messaging interface in response to the instruction of recording prompt. Further, the prompt graph is a virtual button 51 centred at the current position. Much further, the virtual button 51 is a circular virtual button, a square virtual button or a rectangular virtual button. More particularly, a circular virtual button can be a virtual icon with a radius greater than or equal to 5 mm, and a rectangular virtual button can be a rectangular icon with the same proportion as a mobile phone. A person skilled in the art knows that the shape of the virtual button 51 is not limited to the above-mentioned shape, and can be any shape, as long as it is practical and aesthetic.

The vibration prompt unit is used for enabling the touchable screen 10 to vibrate in response to the instruction of recording prompt.

The audio prompt unit is used for sending out a prompt tone in response to the instruction of recording prompt. The prompt tone of the audio prompt unit can be various types of prompt tones, and can be a built-in prompt tone, can also be a user-personalised prompt tone, and can also be a user-downloaded prompt tone.

TABLE 2

| Touch action of | Instruction of | |
|---|---|---|
| touch detector | action interpreter | Mode of voice recorder |
| Action of cancelling | Instruction of | Stop the recording and not |
| voice-sending | cancelling | execute the voice sending |
| | voice-sending | operation |

Table 2 is a further corresponding relationship table of the touch detector 20, the action interpreter 30 and the voice recorder 40. See FIG. 2 and table 2, further, the touch action further comprises an action of cancelling voice-sending, a corresponding control instruction of which is an instruction of cancelling voice-sending, wherein the voice recorder 40 stops the recording and does not execute the voice sending operation in response to the instruction of cancelling voice-sending. In this embodiment, the convenience and fastness of using the instant messaging device 100 is improved by adding an action of cancelling voice-sending. Much further, the action of cancelling voice-sending is a sliding operation from the current position to another position executed by the user on the touchable screen 10 after the instruction of voice recording is sent out; and optionally, the action of cancelling voice-sending is a sliding operation from the current position to another position along any direction.

Further, in this embodiment, the instant messaging device 100 also comprises: a graphic prompt unit, and the graphic prompt unit is used for presenting a virtual button 51 centred at the current position in the instant messaging interface in response to the instruction of recording prompt. Preferably, the virtual button 51 is a circular virtual button, a square virtual button or a rectangular virtual button. The action of cancelling voice-sending is a sliding operation of sliding from the current position to a position other than the virtual button 51 along any direction, for example when the virtual button 51 is a circular virtual button; and the action of cancelling voice-sending is a sliding operation of sliding from the current position to a position other than the circular virtual button along any direction. Preferably, the instruction of cancelling voice-sending is triggered when the sliding distance of the finger is greater than 1 cm.

Much further, in this embodiment, the action of voice recording is formed by the user continuously pressing the touchable screen 10 at any position of the instant messaging interface for a pre-determined time period; the action of voice sending is formed by the user continuously pressing the touchable screen 10 at the current position and then releasing, after the instruction of voice recording is sent out; and the action of cancelling voice-sending and the action of voice recording are actions executed continuously without releasing the touchable screen 10.

Much further, in this embodiment, the action of voice recording is formed by the user continuously pressing the touchable screen 10 at any position of the instant messaging interface for a pre-determined time period and then double clicking the touchable screen for a plurality of times, wherein the double clicks refers to continuously clicking the same position or approximately the same position more than twice; the action of voice sending is formed by the user pressing and then releasing the touchable screen 10 at any position of the instant messaging interface after sending out the instruction of voice recording; The action of cancelling voice-sending is a sliding operation from the current position to another position pressed and executed by the user on any position of the instant messaging interface after the instruction of voice recording is sent out.

See FIG. 2, further, the instant messaging device 100 further comprises a voice judger 60 and a window generator 70. The voice judger 60 is used for determining a signal to noise ratio of the recorded voice; and the window generator 70 is used for generating a confirmation window in the instant messaging interface in response to the action of voice sending when the signal to noise ratio is lower than a pre-set threshold, for receiving a confirmation instruction manually input by the user indicating whether it is allowed to send out the recorded voice, wherein the voice recorder 40 is also configured to send the currently recorded voice to the receiver in the instant messaging interface in response to a confirmation instruction input by the user indicating that sending out is allowed when the signal to noise ratio is lower than the pre-set threshold.

In this embodiment, explanation is made by taking a mobile phone among mobile terminals as an example, when a user unconsciously touches the touchable screen 10 and triggers the voice recording function of the instant messaging device 100, the signal to noise ratio of the recorded voice is automatically judged by means of the instant messaging device 100. When the signal to noise ratio is lower than a pre-set threshold, the instant messaging device 100 will pop out a confirmation window for asking the user about whether to send the voice record, and a confirmation instruction about whether it is allowed to send the voice record is manually input by the user, thus adding the secondary confirmation of the user, reducing the probability of mis-operation.

Further, see FIG. 2, in this embodiment, the instant messaging device 100 further comprises: a listening-state device and a synchronizer; the listening-state device is used for recording the number of times that the user listens to the received specific voice; and the synchronizer is used for synchronizing the number of listening times to an instant message interface of a sender of the specific voice.

In this embodiment, the number of listening times of the recipient can be displayed by the listening-state device, and the number of listening times is synchronized to the sender through the synchronizer, further improving the usage convenience and fastness of the instant message device 100.

Much further, as shown in FIG. 1, in this embodiment, the instant messaging interface is a display area occupying the entire touchable screen 10. Of course, in other embodiments, the instant messaging interface occupies a partial display are of the display area of the entire touchable screen 10.

### Embodiment 2

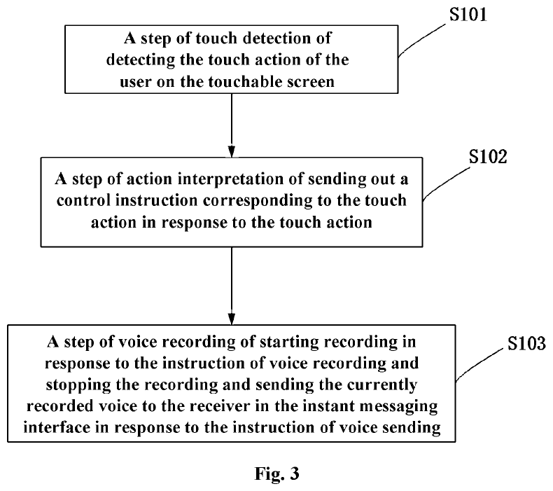

FIG. 3 is an operational flowchart of an instant messaging method according to another embodiment of the present invention. As shown in FIG. 3, the present invention also provides an instant messaging method applied to a device with a is touchable screen 10 (see FIG. 1), wherein the touchable screen 10 (see FIG. 1) is used for displaying an instant messaging interface and is capable of receiving a touch action from a user, and the instant messaging method is carried out according to the following steps:

S101 a step of touch detection of detecting the touch action of the user on the touchable screen 10 (see FIG. 1), the touch action comprising an action of voice recording and an action of voice sending, wherein in this embodiment,

the action of voice recording is formed by the user continuously pressing the touchable screen 10 (see FIG. 1) at any position of the instant messaging interface for a pre-determined time period; and

the action of voice sending is formed by the user continuously pressing the touchable screen 10 (see FIG. 1) at the current position and then releasing, after the instruction of voice recording is sent out; and

S102 a step of action interpretation of sending out a control instruction corresponding to the touch action in response to the touch action, wherein when the touch action serves as the action of voice recording, the corresponding control instruction is an instruction of voice recording, and when the touch action is the action of voice sending, the corresponding control instruction is an instruction of voice sending; and

S103 a step of voice recording of starting recording in response to the instruction of voice recording, and, in response to the instruction of voice sending, stopping recording and sending currently recorded voice to a receiver in the instant messaging interface.

With regard to the instant messaging method of the present invention, by means of the step of touch detection, the step of action interpretation and the step of voice recording, the user continuously presses the instant messaging interface at any position to realize voice recording, and the user keeps pressing and then releases the touchable screen 10 (see FIG. 1) at the current position to realize voice sending; blind operation of voice communication is realized, thus the number of times that a user yields his/her head to operate an instant messaging device 100 (see FIG. 2) tends to zero, improving the convenience and fastness of operation to a great extent, and, taking driving as an example, thereby effectively reducing the risk of driving.

See FIG. 1, in another embodiment, the action of voice recording is formed by the user continuously pressing the touchable screen 10 at any position of the instant messaging interface for a pre-determined time period and then double clicking the touchable screen for a plurality of times. Preferably, the number of double clicks is within six. The time interval between two double clicks is 1 second, or is not greater than 1 second, preferably not greater than 0.5 second. Of course, on other embodiments, another double click time and a corresponding time interval can also be choosing, as long as the purpose of continuously pressing can be reached. The action of voice sending is formed by the user pressing and then releasing the touchable screen 10 at any position of the instant messaging interface after sending out the instruction of voice recording.

By means of the above-mentioned operation, this embodiment not only realizes blind operation of voice communication, thus the number of times that a user yields his/her head to operate an instant messaging device 100 tends to zero, improving the convenience and fastness of operation to a great extent, and, taking driving as an example, thereby effectively reducing the risk of driving, but also realizes hands-free operation, further improving the convenience and fastness of the instant messaging method and the convenient of operation.

Further, the instant messaging method further comprises: a step of prompting, in which step of prompting, a prompt signal is sent out to a user in response to an instruction of recording prompt, wherein the step of action interpretation is also configured to send out the instruction of recording prompt in response to the action of voice recording; and optionally, the instruction of recording prompt and the instruction of voice recording are simultaneously sent out by the step of action interpretation.

In this embodiment, by adding a step of prompting before recording voice, the problem that a user often speaks too early and the beginning of the voice record is not recorded due to that the user does not know when to start recording is solved.

Further, the step of prompt comprises: a step of graphic prompt, a step of vibration prompt and/or a step of audio prompt.

in the graphic prompt unit, a pre-determined prompt graph is presented in the instant messaging interface in response to the instruction of recording prompt.

optionally, the prompt graph is a virtual button 51 (see FIG. 2) centred at the current position; and

optionally, the virtual button 51 (see FIG. 2) is a circular virtual button, a square virtual button or a rectangular virtual button;

in the step of vibration prompt, the touchable screen 10 (see FIG. 1) is enabled to vibrate in response to the instruction of recording prompt; and/or in the step of audio prompt, a prompt tone is sent out in response to the instruction of recording prompt.

Further, the touch action further comprises an action of cancelling voice-sending, a corresponding control instruction of which is an instruction of cancelling voice-sending, wherein the step of voice recording stops the recording and does not execute the voice sending operation in response to the instruction of cancelling voice-sending. In this embodiment, the convenience and fastness of using the instant messaging method is improved by adding an action of cancelling voice-sending.

Further, the action of cancelling voice-sending is a sliding operation from the current position to another position executed by the user on the touchable screen 10 (see FIG. 1) after the instruction of voice recording is sent out; and

optionally, the action of cancelling voice-sending is a sliding operation from the current position to another position along any direction.

Further, the instant messaging method also comprises:

a step of graphic prompt of presenting a virtual button 51 (see FIG. 2) centred at the current position in the instant messaging interface in response to the instruction of recording prompt;

the action of cancelling voice-sending is a sliding operation of sliding from the current position to a position other than the virtual button 51 (see FIG. 2) along any direction; and

optionally, the virtual button 51 (see FIG. 2) is a circular virtual button, a square virtual button or a rectangular virtual button;

further, in this embodiment, the action of voice recording is formed by the user continuously pressing the touchable screen 10 at any position of the instant messaging interface for a pre-determined time period; the action of voice sending is formed by the user continuously pressing the touchable screen 10 at the current position and then releasing, after the instruction of voice recording is sent out; and the action of cancelling voice-sending and the action of voice recording are actions executed continuously without releasing the touchable screen 10. In this embodiment, the convenience and fastness of using the instant messaging method is improved by adding an action of cancelling voice-sending.

Much further, in this embodiment, the action of voice recording is formed by the user continuously pressing the touchable screen 10 at any position of the instant messaging interface for a pre-determined time period and then double clicking the touchable screen for a plurality of times, wherein the double clicks refers to continuously clicking the same position or approximately the same position more than twice; the action of voice sending is formed by the user pressing and then releasing the touchable screen 10 at any position of the instant messaging interface after sending out the instruction of voice recording; The action of cancelling voice-sending is a sliding operation from the current position to another position pressed and executed by the user on any position of the instant messaging interface after the instruction of voice recording is sent out. In this embodiment, the convenience and fastness of using the instant messaging method is improved by adding an action of cancelling voice-sending.

Further, the instant messaging method also comprises: a step of voice judgement and a step of window generation.

In the step of voice judgement, a signal to noise ratio of the recorded voice is determined; and in the step of window generation, a confirmation window is generated in the instant messaging interface in response to the action of voice sending when the signal to noise ratio is lower than a pre-set threshold, so as to receive a confirmation instruction manually input by the user indicating whether it is allowed to send out the recorded voice,

wherein the step of voice recording is also configured to send the currently recorded voice to the receiver in the instant messaging interface in response to a confirmation instruction input by the user indicating that sending out is allowed when the signal to noise ratio is lower than the pre-set threshold.

By means of this embodiment, secondary confirmation of the user is added, reducing the probability of mis-operation.

Further, the instant messaging method also comprises: a step of listening state and a step of synchronization;

in the step of listening state, the number of times that the user listens to the received specific voice is recorded; and

in the step of synchronization, the number of listening times is synchronized to an instant message interface of a sender of the specific voice.

In this embodiment, the number of listening times of the recipient can be displayed by the step of listening state, and the number of listening times is synchronized to the sender through the synchronizer, further improving the usage convenience and fastness of the instant message method.

Up to this, a person skilled in the art should recognize that although a plurality of exemplary embodiments of the present invention have been shown and described in detail herein, numerous other variations or modifications meeting the principle of the present invention can be directly determined or derived according to the contents disclosed in the present invention. Therefore, the scope of the present invention should be construed and deemed as encompassing all these and other variations or modifications.

1. An instant messaging device, characterized by comprising:
a touchable screen for displaying an instant messaging interface and capable of receiving a touch action from a user;
a touch detector for detecting the touch action of the user on the touchable screen, wherein the touch action comprises an action of voice recording and an action of voice sending;
an action interpreter for sending out a control instruction corresponding to the touch action in response to the touch action, wherein when the touch action serves as the action of voice recording, the corresponding control instruction is an instruction of voice recording, and when the touch action is the action of voice sending, the corresponding control instruction is an instruction of voice sending; and
a voice recorder for starting recording in response to the instruction of voice recording, and in response to the instruction of voice sending, stopping recording and sending currently recorded voice to a receiver in the instant messaging interface.

2. The instant messaging device according to claim 1, characterized in that the action of voice recording is formed by the user continuously pressing the touchable screen at any position of the instant messaging interface for a pre-determined time period; and
the action of voice sending is formed by the user continuously pressing the touchable screen at a current position and then releasing after sending the instruction of voice recording.

3. The instant messaging device according to claim 1, characterized in that the action of voice recording is formed by the user continuously pressing the touchable screen at any position of the instant messaging interface for a pre-determined time period and then double clicking the touchable screen for a plurality of times, wherein the double clicks refers to continuously clicking a same position or approximately a same position more than twice;
the action of voice sending is formed by the user pressing and then releasing the touchable screen at any position of the instant messaging interface after sending out the instruction of voice recording;
optionally, the number of double clicks is within six; and
optionally, the time interval between two double clicks is 1 second, or is not greater than 1 second, preferably not greater than 0.5 second.

4. The instant messaging device according to claim 1,
characterized by further comprising:
a prompter for sending out a prompt signal to the user in response to an instruction of recording prompt,
wherein the action interpreter is also configured to send out the instruction of recording prompt in response to the action of voice recording; and
optionally, the instruction of recording prompt and the instruction of voice recording are simultaneously sent out by the action interpreter, wherein the prompter comprises:
a graphic prompt unit for presenting a predetermined prompt graph in the instant messaging interface in response to the instruction of recording prompt; optionally, the prompt graph is a virtual button centred at a current position, and optionally, the virtual button is a circular virtual button, a square virtual button or a rectangular virtual button;
a vibration prompt unit for enabling the touchable screen to vibrate in response to the instruction of recording prompt, and/or
an audio prompt unit for sending out a prompt tone in response to the instruction of recording prompt.

5. (canceled)

6. The instant messaging device according to claim 1, characterized in that the touch action further comprises an action of cancelling voice-sending, a corresponding control instruction of which is an instruction of cancelling voice-sending,
wherein the voice recorder stops the recording and does not execute the voice sending operation in response to the instruction of cancelling voice-sending,
wherein the action of cancelling voice-sending is a sliding operation from the current position to another position executed by the user on the touchable screen after the instruction of voice recording is sent out, and
optionally, the action of cancelling voice-sending is a sliding operation from the current position to another position along any direction.

7. (canceled)

8. The instant messaging device according to claim 7, characterized by further comprising:
a graphic prompt unit for presenting a virtual button centred at the current position in the instant messaging interface in response to the instruction of recording prompt;
the action of cancelling voice-sending is a sliding operation of sliding from the current position to a position other than the virtual button along any direction, and
optionally, the virtual button is a circular virtual button, a square virtual button or a rectangular virtual button,
wherein the action of voice recording is formed by the user continuously pressing the touchable screen at any position of the instant messaging interface for a predetermined time period;
the action of voice sending is forming by the user continuously pressing the touchable screen at the current position and then releasing after sending the instructions of voice recording; and
the action of cancelling voice-sending and the action of voice recording are actions executed continuously without releasing the touchable screen.

9. (canceled)

10. The instant messaging device according to claim 1, characterized by further comprising:
a voice judger for determining a signal to noise ratio of the recorded voice;
a window generator for generating a confirmation window in the instant messaging interface in response to the action of voice sending when the signal to noise ratio is lower than a pre-set threshold, and for receiving a confirmation instruction manually input by the user indicating whether it is allowed to send out the recorded voice;
a listening-state device for recording the number of times that the user listens to the received specific voice, and
a synchronizer for synchronizing the number of listening times to an instant message interface of a sender of the specific voice,
wherein the voice recorder is also configured to send the currently recorded voice to the receiver in the instant messaging interface in response to a confirmation instruction input by the user indicating that sending out is allowed when the signal to noise ratio is lower than the pre set threshold.

11. (canceled)

12. An instant messaging method applied to a device with a touchable screen, wherein the touchable screen is used for displaying an instant messaging interface and is capable of receiving a touch action from a user, characterized in that the instant messaging method is carried out according to the following steps:
a step of touch detection of detecting the touch action of the user on the touchable screen, wherein the touch action comprises an action of voice recording and an action of voice sending;
a step of action interpretation of sending out a control instruction corresponding to the touch action in response to the touch action, wherein when the touch action serves as the action of voice recording, the corresponding control instruction is an instruction of voice recording, and when the touch action is the action of voice sending, the corresponding control instruction is an instruction of voice sending; and
a step of voice recording of starting recording in response to the instruction of voice recording, and in response to the instruction of voice sending, stopping recording and sending the currently recorded voice to a receiver in the instant messaging interface.

13. The instant messaging method according to claim 12, characterized in that the action of voice recording is formed by the user continuously pressing the touchable screen at any position of the instant messaging interface for a pre-determined time period; and
and the action of voice sending is formed by the user continuously pressing the touchable screen at the current position and then releasing after sending the instruction of voice recording.

14. The instant messaging method according to claim 12, characterized in that the action of voice recording is formed by the user continuously pressing the touchable screen at any position of the instant messaging interface for a pre-determined time period and then double clicking the touchable screen for a plurality of times, wherein the double clicks refers to continuously clicking a same position or approximately a same position more than twice;
the action of voice sending is formed by the user pressing and then releasing the touchable screen, after sending out the instruction of voice recording;
optionally, the number of double clicks is within six; and
optionally, the time interval between two double clicks is 1 second, or is not greater than 1 second, preferably not greater than 0.5 second.

15. The instant messaging method according to claim 12, characterized by further comprising:
a step of prompting of sending out a prompt signal to a user in response to an instruction of recording prompt,
wherein the step of action interpretation is also configured to send out the instruction of recording prompt in response to the action of voice recording; and
optionally, the instruction of recording prompt and the instruction of voice recording are simultaneously sent out by the step of action interpretation, wherein the prompt step comprises:
a step of graphic prompt of presenting a predetermined prompt graph in the instant messaging interface in response to the instruction of recording prompt; optionally, the prompt graph is a virtual button centred at the current position, and optionally, the virtual button is a circular virtual button, a square virtual button or a rectangular virtual button;
a step of vibration prompt of enabling the touchable screen to vibrate in response to the instruction of recording prompt; and/or
a step of audio prompt of sending out a prompt tome in response to the instruction of recording prompt.

16. (canceled)

17. The instant messaging method according to claim 12, characterized in that the touch action further comprises an action of cancelling voice-sending, and a corresponding control instruction is an instruction of cancelling voice-sending,
wherein the step of voice recording stops the recording and does not execute the voice sending operation in response to the instruction of cancelling voice-sending,
wherein the action of cancelling voice-sending is a sliding operation from the current position to another position executed by the user on the touchable screen after the instruction of voice recording is sent out; and
optionally, the action of cancelling voice-sending is a sliding operation from the current position to another position along any direction.

18. (canceled)

19. The instant messaging method according to claim 18, characterized by further comprising:
a step of graphic prompt of presenting a virtual button centred at the current position in the instant messaging interface in response to the instruction of recording prompt;
the action of cancelling voice-sending is a sliding operation of sliding from the current position to a position other than the virtual button along any direction; and
optionally, the virtual button is a circular virtual button, a square virtual button or a rectangular virtual button.

20. The instant messaging method according to claim 18, characterized in that the action of voice recording is formed by the user continuously pressing the touchable screen at any position of the instant messaging interface for a pre-determined time period; and
the action of voice sending is formed by the user continuously pressing the touchable screen at the current position and then releasing after sending the instruction of voice recording, and
the action of cancelling voice-sending and the action of voice recording are actions executed continuously without releasing the touchable screen.

21. The instant messaging method according to claim 12, characterized by further comprising:
a step of voice judgement of determining a signal to noise ratio of the recorded voice; and
a step of window generation of generating a confirmation window in the instant messaging interface in response to the action of voice sending when the signal to noise ratio is lower than a pre-set threshold, so as to receive a confirmation instruction manually input by the user indicating whether it is allowed to send out the recorded voice;
a step of listening state of recording the number of times that the user listens to the received specific voice; and
a step of synchronization of synchronizing the number of listening times to an instant message interface of a sender of the specific voice,
wherein the step of voice recording is also configured to send the currently recorded voice to a receiver in the instant messaging interface in response to a confirmation instruction input by the user indicating that sending out is allowed when the signal to noise ratio is lower than the pre-set threshold.

22. (canceled)
